(19) United States
(12) Patent Application Publication
(10) Pub. No.: US 2013/0097994 A1
(43) Pub. Date: Apr. 25, 2013

(54) MULTI-FLUID TURBINE ENGINE

(71) Applicant: Wisdom Energy Technology Co., LTD, Shenzhen (CN)

(72) Inventor: Zhiqiang Wang, Jilin (CN)

(73) Assignee: WISDOM ENERGY TECHNOLOGY CO., LTD, Shenzhen (CN)

(21) Appl. No.: 13/654,573

(22) Filed: Oct. 18, 2012

(30) Foreign Application Priority Data
Oct. 19, 2011 (CN) 201110318160.7

(51) Int. Cl. F01K 23/06; F02C 6/00; F01D 1/02

(52) U.S. Cl. 60/39.182; 415/116

(57) ABSTRACT

A multi-fluid turbine engine includes a turbine, a first working fluid inlet passage, and a second working fluid inlet passage. The turbine may include a first working fluid portion and a second working fluid portion. The first working fluid passage may be configured to introduce a first working fluid to the first working fluid portion to perform work on the first working fluid portion, and the second working fluid inlet passage may be configured to introduce a second working fluid to the second working fluid portion to perform work on the second working fluid portion. The first working fluid inlet passage and the second working fluid passage may be independent of each other.

### FIELD

The present invention relates to turbine engines and, more particularly, to a turbine engine using multiple working fluids.

### BACKGROUND

A gas turbine is a heat engine that performs mechanical work using gas at its working fluid. In a gas turbine, gases passing through the gas turbine undergo three thermodynamic processes. These are isentropic compression, isobaric (constant pressure) combustion and isentropic expansion. Together these make up the Brayton cycle. As with all cyclic heat engines, higher combustion temperatures can generally allow for greater efficiencies. However, temperatures are limited by the ability of the steel, nickel, ceramic, or other materials that make up the engine to withstand high temperatures and stresses.

A steam engine is a heat engine that performs mechanical work using steam as its working fluid. In a steam engine, water turns to steam and reaches a high pressure. When expanded through a turbine, mechanical work is done. The reduced-pressure steam is then released into the atmosphere or recycled. The thermodynamic cycle used to analyze this process is called the Rankine cycle.

A combined-cycle engine combines the Brayton cycle and the Rankine cycle. One such combined-cycled engine is disclosed in U.S. Pat. No. 4,248,039 to Dah Yu Cheng.

### SUMMARY

In one independent embodiment, a multi-fluid turbine engine may generally include a turbine, a first working fluid inlet passage, and a second working fluid inlet passage. The turbine may include a first working fluid portion and a second working fluid portion. The first working fluid passage may be configured to introduce a first working fluid to the first working fluid portion to perform work on the first working fluid portion, and the second working fluid inlet passage may be configured to introduce a second working fluid to the second working fluid portion to perform work on the second working fluid portion. The first working fluid inlet passage and the second working fluid passage may be independent of each other.

In another independent embodiment, a multi-fluid turbine engine may generally include a turbine for converting energy of working fluids into mechanical energy. The turbine may be divided into a number of working fluid portions for respectively receiving different working fluids. The working fluid portions may be divided by a plane through the turbine such that a turbine part included in each of the working fluid portions is always changing as the turbine rotates.

In still another independent embodiment, a multi-fluid turbine engine may generally include a turbine, a gas inlet passage, a steam inlet passage, a gas outlet passage, and a steam outlet passage. The turbine may be divided into a gas portion and a steam portion. The gas inlet passage may be configured to introduce gas to the gas portion of the turbine to perform work on the gas portion. The steam inlet passage may be configured to introduce steam to the steam portion of the turbine to perform work on the steam portion. The gas inlet passage and the steam inlet passage may be independent of each other. The gas outlet passage may be configured to receive gas exhausted from the gas portion of the turbine. The steam outlet passage may be configured to receive steam exhausted from the steam portion of the turbine.

Other independent aspects of the invention will become apparent by consideration of the detailed description, claims and accompanying drawings.

### BRIEF DESCRIPTION OF THE DRAWINGS

FIG. 1 is a schematic diagram of a multi-fluid turbine engine with different turbine portions.

FIG. 2 is a schematic axial plane view of the turbine according to one independent exemplary embodiment.

FIG. 3 is a view showing a simplified representation of the turbine according to one independent embodiment.

FIG. 4-6 illustrate working fluid inlet and outlet passages according to one independent exemplary embodiment.

FIG. 7-8 illustrate a radial turbine engine in which different working fluids perform work on different portions of the turbine.

FIG. 9 illustrates an exemplary two-stage axial turbine according to one independent embodiment.

FIG. 10 illustrates a turbine divided based on a ratio between the first and second working fluids.

FIG. 11 schematically illustrates a multi-fluid turbine engine according to one independent exemplary embodiment.

FIG. 12 schematically illustrates a multi-fluid turbine engine according to another independent embodiment.

### DESCRIPTION OF THE EMBODIMENTS

Before any independent embodiments of the invention are explained in detail, it is to be understood that the invention is not limited in its application to the details of construction and the arrangement of components set forth in the following description or illustrated in the following drawings. The invention is capable of other independent embodiments and of being practiced or of being carried out in various ways. Also, it is to be understood that the phraseology and terminology used herein is for the purpose of description and should not be regarded as limiting. Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof. Further, it is to be understood that such terms as “forward”, “rearward”, “left”, “right”, “upward” and “downward”, etc., are words of convenience and are not to be construed as limiting terms.

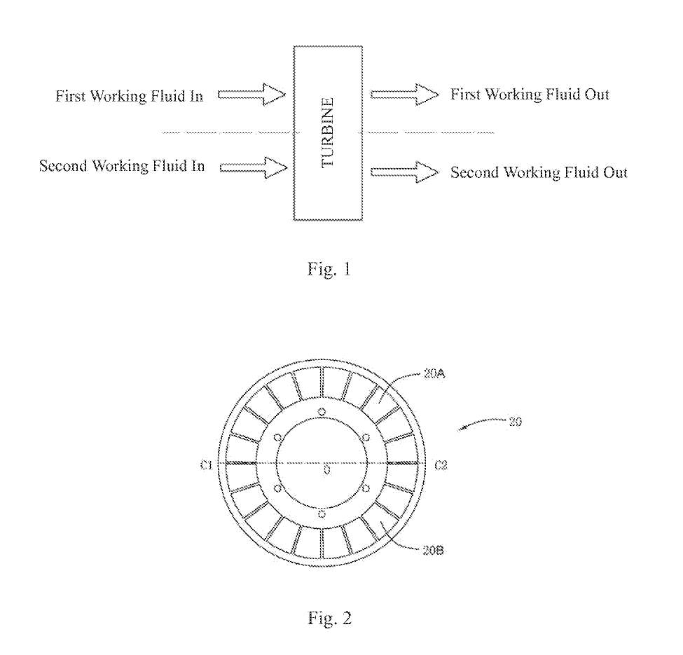

FIG. 1 is a view showing a multi-fluid turbine engine with different turbine portions. The multi-fluid turbine engine includes a turbine 20 that receives working fluids and converts energy of the fluids into mechanical energy. As illustrated in FIG. 1, the working fluids include a first working fluid and a different second working fluid. The first working fluid and the second working fluid are introduced to different turbine portions of the turbine 20, such that the first working fluid and the second working fluid perform work at their respective turbine portions as they expand through their respective turbine portions.

FIG. 2 is a schematic axial plane view of the turbine 20 according to one independent exemplary embodiment. The turbine 20 includes a first turbine portion 20A and a second turbine portion 20B that are divided by a boundary line C1-O-C2 (“O” denotes the center of the turbine 20). The first turbine portion 20A and the second turbine portion 20B respectively receive the first working fluid and the second working fluid, such that the first turbine portion 20A converts substantially only the energy of the first working fluid into mechanical energy and the second turbine portion converts substantially only the energy of the second working fluid into mechanical energy. After the first working fluid and the second working fluid perform work on the turbine 20, they can be further processed as necessary. For example, these working fluids may be exhausted to ambient air or recycled.

To illustrate the concept that the first working fluid and the second fluid are respectively introduced to different turbine portions to perform work, the turbine 20 is described as being divided into the first turbine portion 20A and the second turbine portion 20B. From this viewpoint, the first and second turbine portions may also be termed as first and second working fluid portions, respectively. It is noted, however, that the first turbine portion 20A and the second turbine portion 20B described therein are not specific fixed parts on the turbine 20. Rather, the first turbine portion 20A and the second turbine portion 20B refer to first and second parts of the turbine 20 that are divided by the boundary line C1-O-C2 at any given time point. For example, in FIG. 2, the boundary line C1-O-C2 is horizontal, and, at any given time point, one turbine part rotating to above the horizontal boundary line C1-O-C2 is defined as the first turbine portion 20A or first working fluid portion 20A, and the other turbine part rotating to below the horizontal boundary line C1-O-C2 is defined as the second turbine portion 20A or second working fluid portion 20B. As the turbine 20 rotates, the turbine part included in each turbine portion or working fluid portion 20A, 20B is always changing.

While the turbine 20 is described as being divided into the first working fluid portion 20 and the second working fluid portion 20B by the boundary line C1-O-C2, it is noted that this does not require the turbine 20 itself be designed and manufactured to have such a boundary line C1-O-C2. Rather, this boundary line C1-O-C2 is defined by working fluid inlet passages which are discussed below.

In one embodiment, the first working fluid may include gas, and the second working fluid may include water or steam (steam can be considered as vapor water so sometimes the steam is also termed as water). Accordingly, the first and second turbine portions are sometimes also termed as gas and steam portions. The gas and steam (or water) are two types of most common working fluids used in current turbine engines.

The gas refers to a combustion product of a fuel. The fuel may include, but is not limited to, for example, gasoline, natural gas, propane, diesel oil, kerosene, a renewable fuel, such as E85 alcohol-gasoline, biodiesel and biogas, etc. In other independent embodiments, the first working fluid and the second working fluid may also be other working fluids other than those described above.

When the first working fluid includes the combustion product and the second working fluid includes the steam, the multi-fluid turbine engine described above combines the work performed in the Brayton cycle and the work performed in the Rankine cycle on the same turbine. In comparison with the existing gas-steam combined cycle, the multi-fluid turbine engine described above can have a more compact structure.

As mentioned above, in general, higher turbine inlet temperature results in a higher capability of the gas to perform work and hence a higher efficiency of the turbine engine. However, as the turbine inlet temperature becomes higher and higher, components of turbine, such as the blades, are required to have an increasingly higher heat-resistant capability. The temperature of the working fluid for the Brayton cycle usually exceeds 1000° C. and some even exceed 2000° C. In contrast, the temperature of the working fluid for the Rankine cycle is much lower, usually less than 700° C.

In the illustrated multi-fluid turbine engine, the gas and steam perform work on their respective turbine portions 20A, 20B. As such, at any given time point, only part of the turbine 20 receives the high temperature gas, while the remaining part of the turbine receives the relatively lower temperature steam. As the turbine 20 continuously rotates, the turbine part in the gas portion that receives the high temperature gas can continuously rotate to the steam portion to receive the steam to be cooled by the relatively lower temperature steam.

Also, because the gas and the steam perform work on their respective turbine portions, the steam does not cause a reduction of the temperature of the gas (turbine inlet temperature). In other words, the introduction of the steam does not reduce the capability of the gas to perform work.

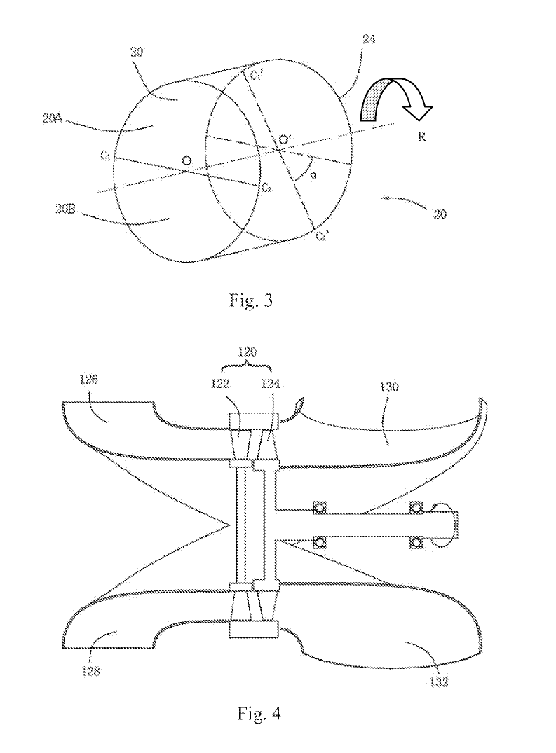

FIG. 3 is a view showing a simplified representation of the turbine 20 according to one independent embodiment. In this embodiment, the turbine 20 is illustrated as a single-stage axial turbine. In the simplified representation, the turbine 20 is represented by a cylinder, without showing the specific structure of the turbine. The turbine 20 rotates, for example, along the clockwise direction indicated by an arrow R shown in FIG. 3. Two opposite surfaces 22 and 24 of the cylinder 20 represent an inlet side 22 and an outlet side 24 of the turbine 20, respectively.

The turbine 20 is divided by a horizontal boundary line C1-O-C2 (with O being the center of the turbine) into a first working fluid portion 20A and a second working fluid portion 20B, each occupying one half of the turbine 20 in the illustrated embodiment. As such, the first working fluid (for example, gas) is introduced to the turbine 20 at one side of the boundary line C1-O-C2, for example, the first working fluid portion 20A above the boundary line C1-O-C2, while the second working fluid (for example, steam) is introduced to the turbine 20 at the other side of the boundary line, for example, the second working fluid portion 20B below the boundary line C1-O-C2. In other words, the first working fluid and the second working fluid have a horizontal inlet boundary line C1-O-C2 at the inlet side 22 of the turbine 20.

Because the turbine 20 continuously rotates in the clockwise direction, the working fluids are also driven to rotate along the clockwise direction R with the turbine 20 when passing through the turbine 20. As a result, when the working fluids leave the turbine 20, the working fluids as a whole deflect along the rotational direction of the turbine at a deflection angle α with respect to the state just before reaching the turbine 20. That is, the first working fluid and the second working fluid leaving the turbine 20 have an outlet boundary line C1′-O-C2′ at the outlet side 24 of the turbine 20, and the outlet boundary line C1′-O-C2′ deflects along the rotational direction at the deflection angle α with respect to the inlet boundary line C1-O-C2. If it is desired to separately process the first working fluid and the second working fluid leaving the turbine 20, this deflection angle must be taken into account. It is to be understood that FIG. 3 only shows the rotor section of the turbine 20 to more clearly illustrate the overall defection of the working fluids when leaving the turbine 20.

The deflection angle α is dependent on parameters such as, for example, turbine inlet pressure and temperature, inlet/exhaust passage parameters, turbine rotational speed, exhaust back pressure, or the like. For example, the deflection angle α decreases with the increase of turbine inlet pressure and temperature, the decrease of the turbine rotational speed, and the decrease of the exhaust back pressure.

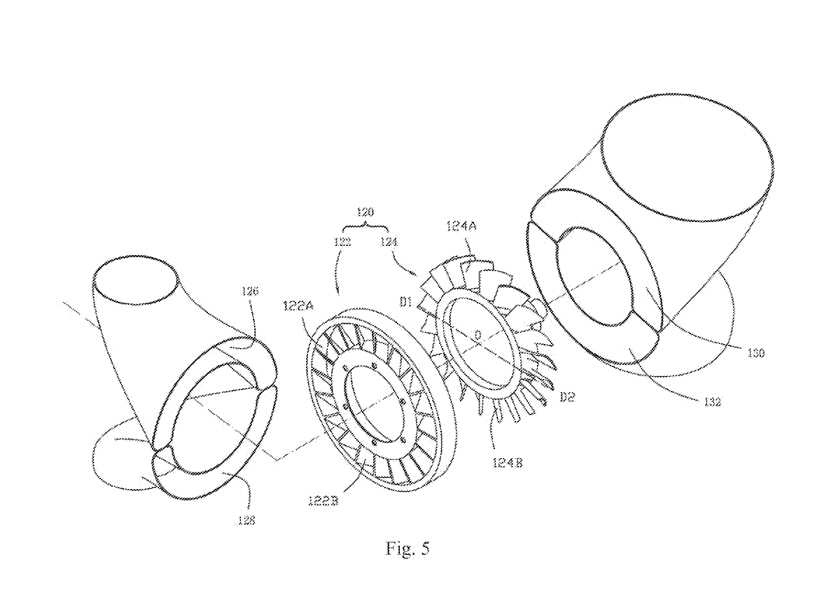

FIG. 4-6 illustrate working fluid inlet and outlet passages according to one independent exemplary embodiment. In this embodiment, the turbine 120 is illustrated as a single-stage turbine. The turbine 120 includes a turbine stator 122 (also referred to as a nozzle) and a turbine rotor 124. The stator 122 includes a first working fluid guide portion 122A and a second working fluid guide portion 122B. The turbine rotor 124 includes a first working fluid portion 124A corresponding to the first working fluid guide portion 122A and a second working fluid portion 124B corresponding to the second working fluid guide portion 122B. The first and second working fluid portions 124A and 124B are divided by (see FIG. 5) an inlet boundary line D1-O-D2 (with O being the center of the turbine 120).

A first working fluid inlet pipe 126 and a second working fluid inlet pipe 128 are disposed at the inlet side of the turbine 120. The first working fluid inlet pipe 126 is in fluid communication with the first working fluid guide portion 122A of the turbine stator 122, such that the first working fluid is introduced to the first working fluid guide portion 122A of the stator 122 and then guided through the first working fluid guide portion 122A to the first working fluid portion 124A of the turbine rotator 124 for performing work. Therefore, the first working fluid inlet pipe 126 and the first working fluid guide portion 122A of the turbine stator 122 (specifically, spaces formed between blades of the first guide portion 122A) cooperatively form a first working fluid inlet passage through which the first working fluid is introduced to the first working fluid portion 124A of the turbine rotor to perform work.

Similarly, the second working fluid inlet pipe 128 is in fluid communication with the second working fluid guide portion 122B, such that the second working fluid is introduced to the second working fluid guide portion 122B and then guided through the second working fluid guide portion 122B to the second working fluid portion 124B of the turbine rotator 124 for performing work. Therefore, the second working fluid inlet pipe 128 and the second working fluid guide portion 122B of the turbine stator 122 (specifically, spaces formed between blades of the second guide portion 122B) cooperatively form a second working fluid inlet passage through which the second working fluid is introduced to the second working fluid portion 124B of the turbine rotor 124 to perform work. The first working fluid inlet passage and the second working fluid inlet passage are independent of each other to separately transmit the first and second working fluids, respectively.

The first and second working fluids leave the first and second working fluid portions 124A, 124B after performing work on the turbine rotor 124. If it is desired to separately process the first and second working fluids leaving the turbine rotor 124, the turbine engine may include, at the outlet of the turbine 120, a first working fluid outlet pipe or passage 130 and a second working fluid outlet pipe or passage 132 that are independent of each other. The first working fluid outlet passage 130 is in fluid communication with the first working fluid portion 124A to receive substantially only the first working fluid that perform work on the first working fluid portion 124A. The second fluid outlet passage 132 is in fluid communication with the second working fluid portion 124B to receive substantially only the second working fluid that perform work on the second working fluid portion 124B.

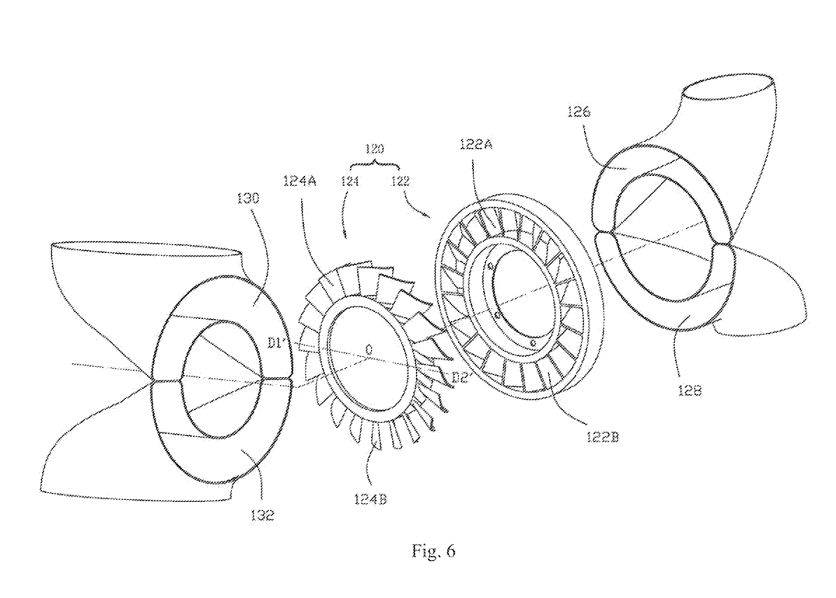

As described above, when leaving the turbine 20, the working fluids as a whole deflect at a deflection angle α along the rotational direction of the turbine 20 with respect to a state of the working fluids before reaching the turbine. That is, an outlet boundary line D1′-O-D2′ (see FIG. 6) between the first working fluid and the second working fluid deflects at the deflection angle α in the rotational direction of the turbine rotor 124 with respect to the inlet boundary line D1-O-D2.

Accordingly, the first working fluid outlet passage 130 and the second working fluid outlet passage 132 are constructed and disposed such that a fluid receiving boundary line defined between the first working fluid outlet passage 130 and the second working fluid outlet passage 132 deflects at the same deflection angle α in the rotational direction of the turbine rotor 124 with respect to the inlet boundary line D1-O-D2, thereby allowing substantially all of the first working fluid performing on the first working fluid portion 124A to enter the first working fluid outlet passage 130 and substantially all of the second working fluid performing on the second working fluid portion 124B to enter the second working fluid outlet passage 132. The deflection angle α may be determined based on parameters such as, for example, turbine inlet pressure and temperature, inlet/exhaust passage parameters, turbine rotational speed, exhaust back pressure, or the like.

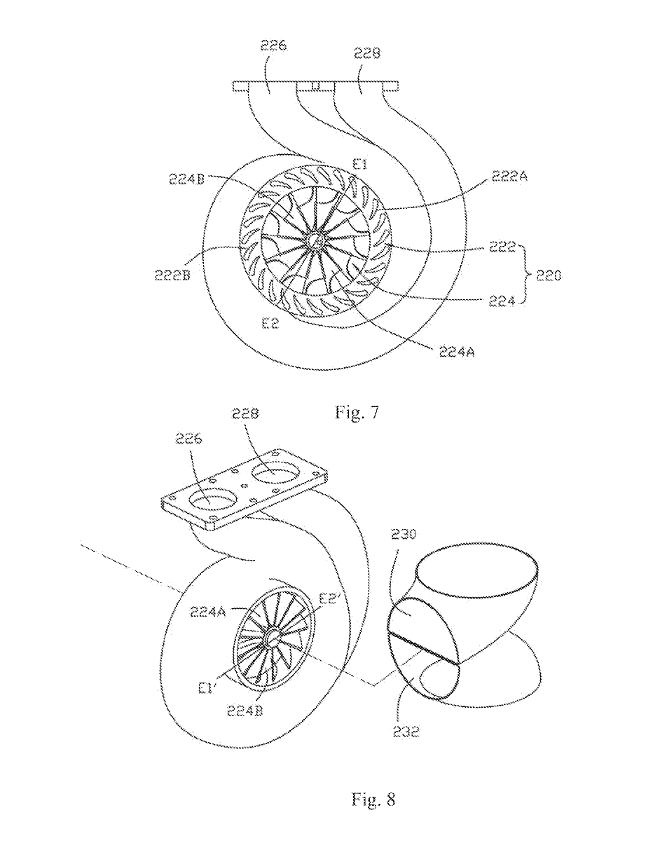

FIG. 7-8 illustrate a radial turbine engine in which different working fluids perform work on different portions of the turbine. Different than an axial turbine, during operation of the radial turbine, working fluids are taken in along a circumferential periphery of the turbine and exhausted in the axial direction. As described below, the radial turbine engine has an inlet boundary line for separating different working fluids. The inlet boundary line is illustrated in this independent exemplary embodiment as equally dividing the turbine. However, this specific example is for the purposes of illustration only and should not be regarded as limiting.

The radial turbine engine includes a turbine 220 with a turbine stator 222 and a turbine rotor 224. The turbine stator 222 includes a first working fluid guide portion 222A and a second working fluid guide portion 222B. The turbine rotor 224 includes a first working fluid portion 224A and a second working fluid portion 224B divided by (see FIG. 7) an inlet boundary line E1-O-E2 (with O being the center of the turbine 220).

The turbine engine includes a first working fluid inlet pipe 226 and a second working fluid inlet pipe 228 that are disposed at an inlet side (i.e., a circumferential periphery) of the turbine 120. The first working fluid inlet pipe 226 is in fluid communication with the first working fluid guide portion 222A of the turbine stator 222, such that the first working fluid is introduced to the first working fluid guide portion 222A of the stator 222 and then guided through the first working fluid guide portion 222A to the first working fluid portion 224A of the turbine rotator 224 for performing work. Therefore, the first working fluid inlet pipe 226 and the first working fluid guide portion 222A of the turbine stator 222 (specifically, spaces formed between blades of the first working fluid guide portion 222A) cooperatively form a first working fluid inlet passage through which the first working fluid is introduced to the first working fluid portion 224A to perform work.

Similarly, the second working fluid inlet pipe 228 is in fluid communication with the second working fluid guide portion 222B of the turbine stator 222, such that the second working fluid is introduced to the second working fluid guide portion 222B of the stator 222 and then guided through the second working fluid guide portion 222B to the second working fluid portion 224B of the turbine rotator 224 for performing work. Therefore, the second working fluid inlet pipe 228 and the second working fluid guide portion 222B of the turbine stator 222 (specifically, spaces formed between blades of the second working fluid guide portion 222B) cooperatively form a second working fluid inlet passage through which the second working fluid is introduced to the second working fluid portion 224B to perform work. The first working fluid inlet passage and the second working fluid inlet passage are independent of each other to separately transmit the first and second working fluids, respectively.

The first and second working fluids leave the first and second working fluid portions 224A, 224B after performing work on the turbine rotor 224. If it is desired to separately process the first and second working fluids leaving the turbine rotor 224, the turbine engine may include, at an outlet side of the turbine 220, a first working fluid outlet pipe or passage 230 and a second working fluid outlet pipe or passage 232 that are independent of each other. The first working fluid outlet passage 230 is in fluid communication with the first working fluid portion 224A of the turbine rotor 224 to receive substantially only the first working fluid that performs work on the first working fluid portion 224A. The second working fluid outlet passage 232 is in fluid communication with the second working fluid portion 224B of the turbine rotor 224 to receive substantially only the second working fluid that performs work on the second working fluid portion 224B.

As described above, when leaving the turbine 220, the working fluids as a whole deflect at a deflection angle in the rotational direction of the turbine 220 with respect to a state of the working fluids just before reaching the turbine 220. That is, an outlet boundary line E1′-O-E2′ between the first working fluid and the second working fluid deflects at the deflection angle in the rotational direction of the turbine rotor 224 with respect to the inlet boundary line E1-O-E2.

Accordingly, the first working fluid outlet passage 230 and the second working fluid outlet passage 232 are constructed and disposed such that a fluid receiving boundary line defined between the first working fluid outlet passage 230 and the second working fluid outlet passage 232 deflects at the same deflection angle in the rotational direction of the turbine rotor 224 with respect to the inlet boundary line E1-O-E2, thereby allowing substantially all of the first working fluid performing on the first turbine portion 224A to enter the first working fluid outlet passage 230 and substantially all of the second working fluid performing on the second turbine portion 224B to enter the second working fluid outlet passage 232. The deflection angle may be determined based on parameters such as, for example, turbine inlet pressure and temperature, inlet/exhaust passage parameters, turbine rotational speed, exhaust back pressure, or the like.

While the turbines 20, 220 are illustrated in the above description as a single-stage turbine, it is noted that the concept of different working fluids performing work on different turbine portions can also be implemented in a multi-stage turbine. Because most current multi-stage turbines are multi-stage axial turbines, the following description takes the multi-stage axial turbine as an example. However, it is to be understood that the concept disclosed herein can also be applied to a multi-stage radial turbine.

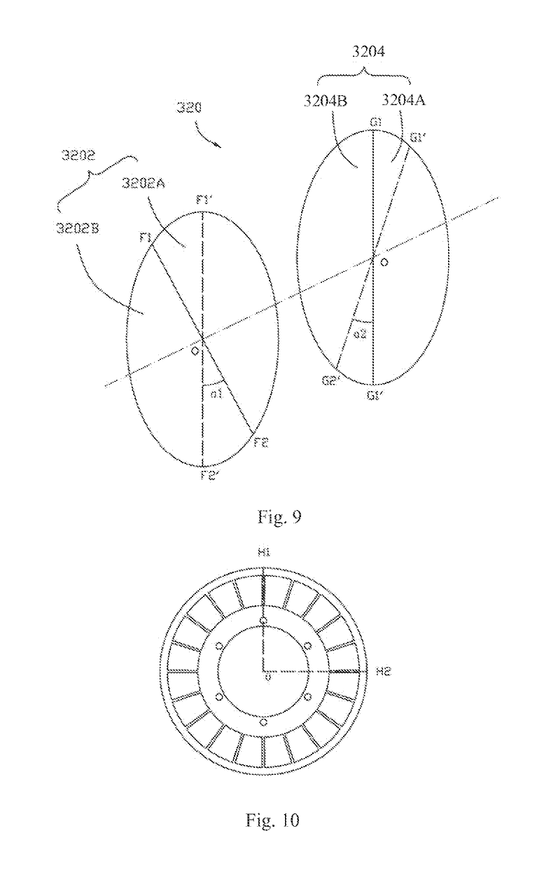

FIG. 9 illustrates an exemplary two-stage axial turbine according to one independent embodiment. In this embodiment, the turbine 320 includes a first stage turbine 3202 and a second stage turbine 3204. It should be understood that the concept described herein can also be applied to a turbine having more than two stages.

To simplify the description, in FIG. 9, each stage turbine is represented by a disc without showing the specific structure of the turbine. The first stage turbine 3202 includes a first working fluid portion 3202A and a second working fluid portion 3202B divided by a boundary line F1-O-F2 (with O being the center of the turbine), and a second stage turbine 3204 includes a first working fluid portion 3204A and a second working fluid portion 3204B divided by a boundary line G1-O-G2 (with O being the center of the turbine). First and second working fluids perform work on the first and second stage turbines 3202, 3204 as they pass therethrough.

The first working fluid portion 3202A and the second working fluid portion 3202B of the first stage turbine 3202 are separated by the boundary line F1-O-F2, which means that the first stage inlet boundary line between the first and second working fluids is also the line F1-O-F2. As described above, when the first and second working fluids leave the first and second turbine portions 3202A and 3202B after performing work thereon, the first and second working fluids as a whole deflect at a deflection angle α1 in the rotational direction of the turbine 3202 with respect to the inlet boundary line F1-O-F2. That is, a first stage outlet boundary line F1′-O-F2′ (shown in dashed line) between the first and second working fluids leaving the turbine has the deflection angle α1 with respect to the first stage inlet boundary line F1-O-F2.

When the first and second working fluids leaving the first stage turbine 3202 reach the second stage turbine 3204, the second stage inlet boundary line G1-O-G2 is approximately parallel to the first stage inlet boundary line F1′-O-F2′ and therefore has approximately the same deflection angle α1 with respect to the first stage inlet boundary line F1-O-F2. When the first and second working fluid leave the second stage turbine 3204 after performing work thereon, a second stage outlet boundary line G1′-O-G2′ (shown in dashed line) between the first and second working fluids leaving the second stage turbine 3204 has a deflection angle α2 with respect to the second stage inlet boundary line G1-O-G2. Therefore, with respect to the first stage inlet boundary line F1-O-F2, the second stage outlet boundary line G1′-O-G2′ has approximately a deflection angle α1+α2. As such, after passing through the whole multi-stage turbine, the deflection angle of the first and second working fluids as a whole can be considered as approximately a sum of the deflection angles occurring at respective stage turbines (e.g., α1+α2). If it is desired to separately process (e.g., recycle) the first and second working fluids exhausted from the multi-stage turbine 320, this deflection angle (α1+α2) is taken into account.

In one independent embodiment, the first stage turbine may be a turbine for directly receiving the steam and gas from a steam source and gas source (i.e., combustion chamber), which transmits at least part of its kinetic energy to a compressor of the turbine engine through a transmission shaft. The second stage turbine and the first stage turbine may have no mechanical connection therebetween. The working fluids leaving the first stage turbine continue to perform work on and thus rotate the second stage turbine such that the second stage turbine can drive a load such as a generator.

In those embodiments described above, the turbine is equally divided into two halves in a rotational direction of the turbine. It is to be understood that this particular dividing manner is illustrative rather than restrictive. The turbine may be divided into working fluid portions in the rotational direction of the turbine in a different manner according to parameters and characteristics of the working fluids. For example, FIG. 10 illustrates a turbine being divided based on a ratio between the first and second working fluids. Assuming that, for example, the ratio of the first working fluid (e.g., gas) to the second working fluid (e.g., steam) is 3:1 (i.e., the first working fluid occupies 75%, and the second working fluid occupies 25%), the turbine of FIG. 10 is divided by a boundary line H1-O-H2 (with O being the center of the turbine) into a first working fluid portion occupying ¾ of the entire turbine and a second working fluid portion occupying ¼ of the entire turbine.

FIG. 11 illustrates a multi-fluid turbine engine according to one independent exemplary embodiment. The multi-fluid turbine engine 400 includes a turbine 420, a gas inlet passage 430 for providing gas (first working fluid) to the turbine 420, a steam inlet passage 432 for providing steam (second working fluid) to the turbine 420, a gas outlet passage 434 for receiving gas exhausted from the turbine 420, and a steam outlet passage 436 for receiving steam exhausted from the turbine 420.

The gas and steam are respectively introduced to different portions of the turbine 420 to perform work. The turbine 420 as well as the inlet and outlet passages 430, 432, 434, 436 may be constructed in the similar manner to those described above with reference to FIG. 2-10, or in another suitable manner.

In the illustrated embodiment, the gas as the first working fluid is supplied from a combustion chamber 440. The combustion chamber 440 may receive compressed air from a compressor 442 and fuel from a fuel source (not shown). Combustion of the fuel and air in the combustion chamber 440 results in the combustion product (i.e., the gas) as the first working fluid.

The steam, as the second working fluid exhausted from the turbine 420, may be recycled by a water recycling system 444. The water recycling system 444 processes and recycles or returns some or all of the steam from the steam outlet passage 436 to the steam inlet passage 432. In the illustrated embodiment, the water recycling system 444 includes a condenser 446 and a recuperator unit.

The condenser 444 is configured to condense the steam from the steam outlet passage 436 into liquid water. The condenser 444 may operate in various manners including, but not limited to, natural cooling, air cooling, water (e.g. sea water) cooling, as long as it can convert the steam into liquid water.

The recuperator unit is configured to heat the liquid water (the second working fluid) condensed by the condenser 446 with the heat recovered from at least one of the gas from the gas outlet passage 434 and the steam from the steam outlet passage 436. In the illustrated embodiment, the recuperator unit includes a first exchanger 448 and a second exchanger 450.

The first heat exchanger 448 heats the condensed liquid water with the heat recovered from the steam from the steam outlet passage 436, such that the liquid water increases in temperature or is heated to steam. The second heat exchanger 450 is connected between the first heat exchanger 448 and the steam inlet passage 432, which further heats the heated water or steam (second working fluid) from the first heat exchanger with the heat recovered from the hot gas from the gas outlet passage 434. The heated steam (second working fluid) then enters the turbine 420 through the steam inlet passage 432.

After heating the steam as the second working fluid, the gas generally still has a high temperature. Therefore, the heat of gas exhausted from the second heat exchanger 450 may be recovered once again, for example, by another heat exchanger (not shown) to heat another fluid.

If the gas and steam were mixed, the condenser may need to be made with a prohibitively large size due to the huge amount of the whole exhaust that needs to be processed. In addition, the gas contains acidic materials that corrode pipes of the water recycling system, which may also increase difficulties in recycling the water if the gas and steam were mixed.

In contrast, in the multi-fluid turbine engine system illustrated in FIG. 11, the gas and steam perform work on different portions of the turbine, which allows for separate processing or recycling of the exhaust gas or steam. This may greatly simplify the process of recycling the water or steam and, hence, may reduce the recycling cost. Furthermore, the condenser reduces the exhaust back pressure of the turbine which, thus may greatly enhance the efficiency of the turbine engine.

In one independent embodiment, the water is stored in the water recycling system 444 when the engine is not in operation. Therefore, at the system start-up, there is no steam introduced into the turbine. Rather, only the gas is used during the start-up period. After the system is started, the water stored in the water recycling system 444 is heated by the exhaust gas (first working fluid) to steam (second working fluid) that is then introduced to the turbine to perform work through the steam inlet passage 432.

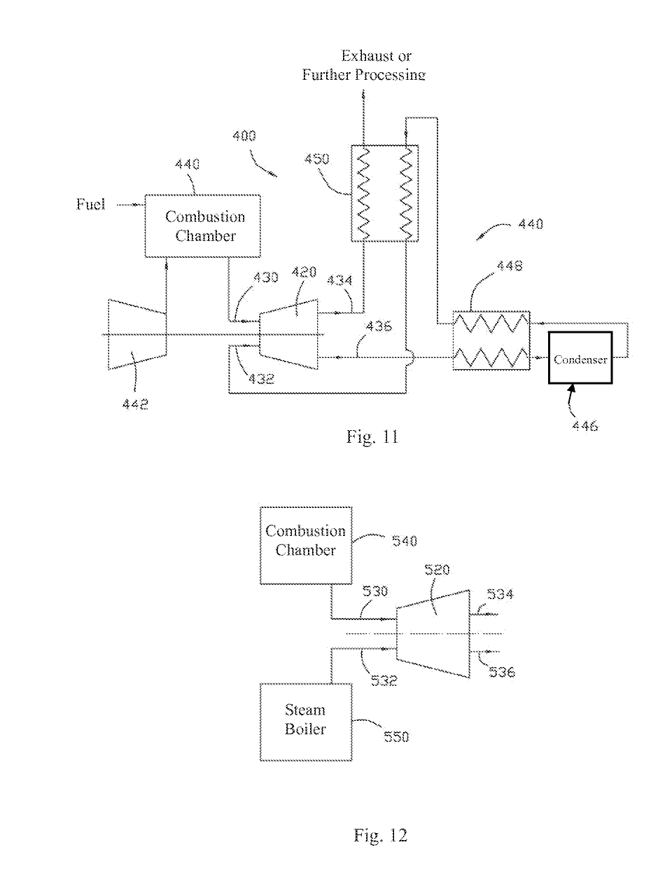

FIG. 12 illustrates a multi-fluid turbine engine 500 according to another independent embodiment. The turbine engine 500 includes a turbine 520, a gas inlet passage 530 for providing gas (first working fluid) to the turbine 520, a steam inlet passage 532 for providing steam to the turbine 520, a gas outlet passage 534 for receiving the exhaust gas from the turbine 520, and a steam outlet passage 536 for receiving the exhaust steam from the turbine 52.

The gas and steam are respectively introduced to different portions of the turbine 520 to perform work. The turbine 520 as well as the inlet and outlet passages 530, 532, 534, 536 may be constructed in the similar manner to those described above with reference to FIG. 2-11, or in another suitable manner.

As shown in FIG. 12, the gas, as the first working fluid, is supplied from a combustion chamber 540, and the steam, as the second working fluid, is supplied from a steam boiler 550. The heat of the gas and steam exhausted through the outlet passages 534 and 536 can be recovered to, for example, heat water in the water boiler 550, and the water can be recycled. Because the first working fluid and the second working fluid also perform work on different portions of the turbine, the turbine engine of FIG. 12 can likewise have one or more of the independent advantages achieved by the turbine engines described above.

While the turbine engines of the independent embodiments described above are illustrated as having two different working fluids (i.e., gas and steam), it is to be understood, however, that the concept of different working fluids working on different portions of the turbine is also applicable in situations in which more than two working fluids are used. If more than two working fluids are used, the turbine would include a corresponding number of the working fluid portions, divided accordingly, as well as a corresponding number of the fluid inlet and outlet passages.

In addition, in the context of the present disclosure, the same type of working fluid having a different working parameter (e.g., temperature) can also be considered as a different working fluid. Taking the gas an example, a first gas and a second gas having different temperatures can be considered as two different working fluids although they are both gas. Accordingly, gases (or steam or another working fluid) having different temperatures (or other working parameters) working on different portions of the turbine also falls within the scope of the present invention.

As illustrated in FIGS. 1-12, by way of examples, the invention may generally provide, among other things, a turbine in which different working fluids work on their respective working fluid portions of the turbine. Because different working fluids work on different turbine portions, the turbine engine may combine advantages of different working fluids while preventing the different working fluids from affecting one another.

For example, with respect to working fluids having different temperature, the higher temperature working fluid works on only part of the turbine at any given time point. Therefore, as the turbine continuously rotates, the lower temperature working fluid can cool the turbine part that previously received the higher temperature working fluid, thereby increasing the reliability of the turbine components and prolonging the lifespan of the turbine.

Also, in some independent embodiments, because different working fluids work on different turbine portions, separate processing or recycling of the different exhaust working fluids is made possible. In particular, when water or steam is used as one of the working fluids, this may simplify the process of water recycling and, thus, may reduce the recycling cost.

It will be apparent to those skilled in the art that various modifications and variations can be made to the disclosed structure without departing from the scope or spirit of the invention. In view of the foregoing, it is intended that the present invention cover modifications and variations of this invention provided they fall within the scope of the following claims and their equivalents.

What is claimed is:

1. A multi-fluid turbine engine comprising:
a turbine including a first working fluid portion and a second working fluid portion;
a first working fluid inlet passage configured to introduce a first working fluid to the first working fluid portion to perform work on the first working fluid portion; and
a second working fluid inlet passage configured to introduce a second working fluid to the second working fluid portion to perform work on the second working fluid portion, the first working fluid inlet passage and the second working fluid passage being independent of each other.

2. The multi-fluid turbine engine according to claim 1, further comprising:
a first working fluid outlet passage disposed at an outlet side of the turbine and configured to receive substantially only the first working fluid leaving the turbine; and
a second working fluid outlet passage disposed at an outlet side of the turbine and configured to receive substantially only the second working fluid leaving the turbine.

3. The multi-fluid turbine engine according to claim 2, wherein the first working fluid portion and the second working fluid portion are divided by an inlet boundary line, wherein the first working fluid outlet passage and the second working fluid outlet passage define a working fluid receiving boundary line at the outlet side of the turbine, and wherein the working fluid receiving boundary line deflects at a deflection angle in a rotational direction of the turbine with respect to the inlet boundary line such that substantially all the first working fluid leaving the turbine enters the first working fluid outlet passage and substantially all the second working fluid leaving the turbine enters the second working fluid outlet passage.

4. The multi-fluid turbine engine according to claim 2, wherein the second working fluid includes steam, and wherein the multi-fluid turbine engine further comprises a water recycling system for recycling the steam from the second working fluid outlet passage.

5. The multi-fluid turbine engine according to claim 4, wherein the water recycling system includes a condenser configured to condense the steam from the second working fluid outlet passage into liquid water to reduce an exhaust back pressure.

6. The multi-fluid turbine engine according to claim 5, wherein the water recycling system further includes a recuperator unit configured and disposed to heat the water condensed by the condenser with heat recovered from at least one of the first working fluid and the second working fluid leaving the turbine.

7. The multi-fluid turbine engine according to claim 4, wherein water is stored in the water recycling system when the turbine engine is not in operation, and the water is heated to steam as the second working fluid with heat recovered from the first working fluid after the turbine engine is started.

8. The multi-fluid turbine engine according to claim 1, wherein the turbine includes a multi-stage turbine.

9. The multi-fluid turbine engine according to claim 1, wherein the first working fluid includes gas, wherein the second working fluid includes steam, and wherein the multi-fluid turbine engine further comprises:
a combustion chamber for providing the gas; and
a steam boiler for providing the steam.

10. A multi-fluid turbine engine comprising:
a turbine for converting energy of working fluids into mechanical energy, the turbine being divided into a plurality of working fluid portions for respectively receiving different working fluids, the working fluid portions being divided along a plane of the turbine such that a turbine part included in each of the working fluid portions changes as the turbine rotates.

11. The multi-fluid turbine engine according to claim 10, wherein the plurality of working fluid portions include a first working fluid portion and a second working fluid portion, and wherein the working fluid received by the first working fluid portion is gas, and the working fluid received by the second working fluid portion is steam.

12. The multi-fluid turbine engine according to claim 11, further comprising a water recycling system for recycling the steam leaving the second working fluid portion.

13. The multi-fluid turbine engine according to claim 12, wherein the water recycling system includes
a condenser configured and disposed to condense the steam leaving the second turbine portion into liquid water, and
a recuperator unit configured and disposed to heat the liquid water condensed by the condenser with heat recovered from at least one of the gas and the steam exhausted from the turbine.

14. The multi-fluid turbine engine according to claim 11, and further comprising:
a combustion chamber for providing the gas; and
a steam boiler for providing the steam.

15. The multi-fluid turbine engine according to claim 10, wherein the turbine includes a multi-stage turbine, with each stage turbine including a corresponding number of working fluid portions.

16. The multi-fluid turbine engine according to claim 10, wherein the turbine includes one of an axial turbine and a radial turbine.

17. A multi-fluid turbine engine comprising:
a turbine divided into a gas portion and a steam portion;
a gas inlet passage configured to introduce gas to the gas portion of the turbine to perform work on the gas portion;
a steam inlet passage configured to introduce steam to the steam portion of the turbine to perform work on the steam portion, the gas inlet passage and the steam inlet passage being independent of each other;
a gas outlet passage configured to receive gas exhausted from the gas portion of the turbine; and
a steam outlet passage configured to receive steam exhausted from the steam portion of the turbine.

18. The multi-fluid turbine engine according to claim 17, wherein the turbine has an inlet side and an outlet side, wherein the gas inlet passage and the steam inlet passage define an inlet boundary line at the inlet side, wherein the gas outlet passage and the steam outlet passage define a fluid receiving boundary line at the outlet side, and wherein the fluid receiving boundary line deflects at a deflection angle in a rotational direction of the turbine with respect to the inlet boundary line.

19. The multi-fluid turbine engine according to claim 17, wherein the gas portion and the steam portion of the turbine are divided in a rotational direction of the turbine.

20. The multi-fluid turbine engine according to claim 17, further comprising a water recycling system including
a condenser configured and disposed to condense the steam exhausted from the steam portion into liquid water,
a first heat exchanger configured and disposed to heat the liquid water condensed by the condenser with heat recovered from the steam exhausted from the steam portion, and
a second heat exchanger configured and disposed to heat the fluid from the first heat exchanger with heat recovered from the gas exhausted from the gas portion.
